(19) United States
(12) Patent Application Publication
(10) Pub. No.: US 2016/0078359 A1
(43) Pub. Date: Mar. 17, 2016

(54) SYSTEM FOR DOMAIN ADAPTATION WITH A DOMAIN-SPECIFIC CLASS MEANS CLASSIFIER

(71) Applicant: Xerox Corporation, Norwalk, CT (US)

(72) Inventors: Gabriela Csurka, Crolles (FR); Boris Chidlovskii, Meylan (FR); Florent C. Perronnin, Domene (FR)

(21) Appl. No.: 14/504,837

(22) Filed: Oct. 2, 2014

(30) Foreign Application Priority Data
Sep. 12, 2014 (EP) 14306412.9

(51) Int. Cl. G06N 7/00; G06N 99/00

(52) U.S. Cl. CPC G06N 7/005; G06N 99/005

(57) ABSTRACT

A classification system includes memory which stores, for each of a set of classes, a classifier model for assigning a class probability to a test sample from a target domain. The classifier model has been learned with training samples from the target domain and from at least one source domain. Each classifier model models the respective class as a mixture of components, the component mixture including a component for each source domain and a component for the target domain. Each component is a function of a distance between the test sample and a domain-specific class representation which is derived from the training samples of the respective domain that are labeled with the class, each of the components in the mixture being weighted by a respective mixture weight. Instructions, implemented by a processor, are provided for labeling the test sample based on the class probabilities assigned by the classifier models.

This application claims the priority of European Patent Application No. EP14306412.9, filed Sep. 12, 2014, entitled “SYSTEM FOR DOMAIN ADAPTATION WITH A DOMAIN-SPECIFIC CLASS MEANS CLASSIFIER,” which is incorporated herein by reference in its entirety.

### BACKGROUND

The exemplary embodiment relates to machine learning and finds particular application in connection with the learning of classifiers using out-of-domain labeled data.

The number of digital items that are available, such as single images and videos is increasing rapidly. These exist, for example, in broadcasting archives, social media sharing websites, and corporate and government databases. Only a small fraction of these items is consistently annotated with labels which represent the content of the item, such as the visual objects which are recognizable within an image.

One approach for classification of datasets employs a Nearest Class Mean (NCM) classifier. In this approach, each class is represented by its mean feature vector, i.e., the mean of all the feature vectors of the images in the database that are labeled with that class (see, e.g., Webb, A., “Statistical Pattern Recognition,” Wiley (2002); Veenman, C., et al. “LESS: a model-based classifier for sparse subspaces,” IEEE TPAMI 27, pp. 1496-1500 (2005); Zhou, X., et al., “Sift-bag kernel for video event analysis,” ACM Multimedia (2008); Mensink, T., et al., “Distance-based image classification: Generalizing to new classes at near zero cost,” IEEE TPAMI 35 (11) pp. 2624-2637 (2013), hereinafter, “Mensink 2013,” and U.S. Pub. No. 20140029839. The classifier of Mensink 2013, for example, computes a comparison measure between a representation of a sample to be classified and a respective class representation for each of a set of classes. A transformation is used to embed the representations. The learned transformation optimizes an objective function which maximizes, over labeled training samples, a likelihood that a labeled sample will be classified with a correct label. The existing methods, however, rely on the existence of in-domain data for training the classifiers.

The shortage of labeled data for training classifiers in specific domains is a significant problem in machine learning applications since the cost of acquiring data labels is often high. Domain adaptation is one way to address this problem by leveraging labeled data in one or more related domains, often referred as “source” domains, when learning a classifier for labeling unseen data in a “target” domain. The source and target domains are assumed to be related but not identical.

However, for classifier models that are learned on source domains, the performance in the target domain tends to be poor. This is especially true in computer vision applications where existing image collections used for object categorization present specific characteristics which often prevent a direct cross-dataset generalization. One reason is that even when the same features are extracted in both domains, the underlying causes of the domain shift (such as changes in the camera, image resolution, lighting, background, viewpoint, and post-processing) can strongly affect the feature distribution. Thus, the assumptions of the classifier trained on the source domain do not always hold for the target domain.

Similarly, corporate document collections, such as emails, orders, invoices, and reports, may have the same class labels but the document content and layout may vary considerably from one customer to another. Accordingly, adapting a document (image) classification model from one customer to another may not yield a sufficiently good accuracy without significant amounts of costly labeled data in the target domain.

There has been considerable interest in domain adaptation. Jiang, J., “A literature survey on domain adaptation of statistical classifiers,” Technical report pp. 1-12 (2008), and Beijbom, O. “Domain adaptations for computer vision applications,” Technical report, arXiv:1211.4860v1 [cs.CV] 20 pp. 1-9 (November 2012) provide surveys focusing on learning theory and natural language processing applications and computer vision applications. Some approaches focus on transforming the feature space in order to bring the domains closer. In some cases, an unsupervised transformation, generally based on PCA projections, is used. See, Gopalan, R., et al., “Domain adaptation for object recognition: An unsupervised approach,” ICCV, pp. 999-1006 (2011); Gong, B., et al., “Geodesic flow kernel for unsupervised domain adaptation,” CVPR, pp. 2066-2073 (2012); and Fernando, B., et al., “Unsupervised visual domain adaptation using subspace alignment,” ICCV, pp. 2960-2967 (2013). In others, metric learning that exploits class labels (in general both in the source and in the target domain) is used to learn a transformation of the feature space such that in this new space the instances of the same class become closer to each other than to instances from other classes, independently of the domain to which they belong. See, Zha, Z.-J., et al., “Robust distance metric learning with auxiliary knowledge,” IJCAI, pp 1327-1332 (2009); Saenko, K., et al., “Adapting visual category models to new domains,” ECCV, Vol. 6314 of Lecture Notes in Computer Science, pp. 213-226 (2010); Kulis, B., et al., “What you saw is not what you get: Domain adaptation using asymmetric kernel transforms,” CVPR, pp. 1785-1792 (2011); and Hoffman, J., et al., “Discovering latent domains for multisource domain adaptation,” ECCV, Vol. Part II, pp. 702-715 (2012).

Unlabeled target instances have also been used in domain adaptation. See, Tommasi, T., et al., “Frustratingly easy NBNN domain adaptation,” ICCV, pp. 897-904 (2013), and Saha, A., et al., “Active supervised domain adaptation,” ECML PKDD, pp. 97-112 (2011). Duan, L., et al., “Domain transfer SVM for video concept detection,” CVPR, pp. 1375-1381 (2009), proposes using unlabeled target data to measure the data distribution mismatch between the source and target domain. Duan's domain transfer SVM generalizes sample re-weighting of Kernel Mean Matching (KMM) by simultaneously learning the SVM decision function and the kernel such that the difference between the means of the source and target feature distributions (including the unlabeled ones) are minimized.

All of these methods, however tend to be computationally expensive or require considerable amounts of target domain data for good classifier performance. There remains a need for a system and method for efficient generation of a classifier which makes use of out-of-domain data.

### INCORPORATION BY REFERENCE

The following references, the disclosures of which are incorporated herein by reference in their entireties, are mentioned:

U.S. Pub. No. 20140029839, published Jan. 30, 2014, entitled METRIC LEARNING FOR NEAREST CLASS MEAN CLASSIFIERS, by Thomas Mensink, et al.

U.S. Pub. No. 20140247461, published Sep. 4, 2014, entitled SYSTEM AND METHOD FOR HIGHLIGHTING BARRIERS TO REDUCING PAPER USAGE, by Jutta K. Willamowski, et al.

U.S. Pub. No. 20120143853, published Jun. 7, 2012, entitled LARGE-SCALE ASYMMETRIC COMPARISON COMPUTATION FOR BINARY EMBEDDINGS, by Albert Gordo, et al.

U.S. Pub. No. 20130182909, published Jul. 18, 2013, entitled IMAGE SEGMENTATION BASED ON APPROXIMATION OF SEGMENTATION SIMILARITY, by Jose Antonio Rodriguez Serrano.

U.S. Pub. No. 20130290222, published Oct. 31, 2013, entitled RETRIEVAL SYSTEM AND METHOD LEVERAGING CATEGORY-LEVEL LABELS, by Albert Gordo, et al.

### BRIEF DESCRIPTION

In accordance with one aspect of the exemplary embodiment, a classification system includes memory which stores, for each of a set of classes, a classifier model for assigning a class probability to a test sample from a target domain. The classifier model has been learned with training samples from the target domain and training samples from at least one source domain different from the target domain. Each classifier model models the respective class as a mixture of components. The mixture of components includes a component for each of the at least one source domain and a component for the target domain. Each of the components is a function of a distance between the test sample and a domain-specific class representation. The domain-specific class representation is derived from the training samples of the respective domain that are labeled with the class. Each of the components in the mixture is weighted by a respective mixture weight. Instructions are provided in memory for labeling the test sample based on the class probabilities assigned by the classifier models. A processor in communication with the memory executes the instructions.

In accordance with another aspect of the exemplary embodiment, a classifier learning method is provided. For each of a set of domains, the set including a target domain and at least one source domain, the method includes providing a set of samples. The source domain samples are each labeled with a class label for one of a set of classes. Fewer than all of the target domain samples are labeled with any of the class labels. A classifier model is learnt for each class with the target domain training samples and the training samples from the at least one source domain. Each classifier model models the respective class as a mixture of components. The mixture of components includes a component for each of the at least one source domain and a component for the target domain. Each of the components is a function of a distance between the test sample and a domain-specific class representation which is derived from the training samples of the respective domain that are labeled with the class. Each of the components in the mixture is weighted by a respective mixture weight.

One or more of the steps of the method may be performed with a processor.

In accordance with another aspect of the exemplary embodiment, a method for learning a metric for a classifier model includes, for each of a set of domains including a target domain and at least one source domain, providing a set of samples. The source domain samples are each labeled with a class label for one of a set of classes. Fewer than all of the target domain samples have class labels. An active training set is composed from the labeled training samples. A metric is provided for embedding samples in an embedding space. For each of a plurality of iterations, the method includes performing at least one of adding to the active training set a most confident unlabeled target domain sample for each class, and removing from the active training set a least confident source domain sample from each class and retraining the metric based on the active training set. The confidence used to remove and add samples is based on a classifier model that includes the trained metric. In the classifier model, each class is modeled as a mixture of components, where there is one mixture component for each source domain and one for the target domain.

One or more of the steps of the method may be performed with a processor.

### BRIEF DESCRIPTION OF THE DRAWINGS

FIG. 1 graphically illustrates exploiting class and domain-related labels to learn a transformation of the feature space such that inter-class distances are decreased and intra-class distances are increased independently of the domain;

FIG. 2 is a functional block diagram of a system for classifier training and/or classification of samples, such as image signatures, in accordance with one aspect of the exemplary embodiment; and

FIG. 3 is a flow chart illustrating a classification method in accordance with another aspect of the exemplary embodiment.

### DETAILED DESCRIPTION

Aspects of the exemplary embodiment relate to a computer-implemented system and method for learning a classifier model suited to predicting class labels for samples in a target domain. The classifier model is learned using samples both from the target domain and from one or more source domains. Aspects also relate to a system and method for classifying samples in the target domain with the learned classifier model.

In one exemplary embodiment, the samples used in training the classifier and those to be classified are multidimensional features-based representations of images, such as photographic images or scanned images of documents. The features on which the representations are based can be extracted from patches of the images. However, the method is not limited to images or to any specific type of sample representation.

The exemplary system and method address one of the main issues of domain adaptation, which is how to deal with data sampled from different distributions and how to compensate for the mismatch by making use of information coming from both source and target domains. During the learning process, the exemplary system adapts the classifier model automatically.

The learning of the classifier model can be performed when there is little or no training data available for the target domain but abundant training data from one or several source domains. The exemplary classifier model may be similar, in some respects, to a Nearest Class Mean (NCM) classifier as described by Mensink 2013, and others, but makes use of domain-dependent class representations (such as domain-specific class means (DSCM)) as well as domain-specific weights. In some embodiments, similarity between a training sample and a domain-dependent class representation is computed in a different feature space by applying a learned metric (transformation) to the data. In some embodiments, the parameters of the classifier model are learned with a generic semi-supervised metric learning method that iteratively curates the training set by adding unlabeled samples with high prediction confidence and by removing the labeled samples for which the prediction confidence is low. These various approaches, which may be employed singly or in combination, have been evaluated on an image dataset. While the method yields good results without any learning procedure (besides computing the per-class and per-domain means), the results suggest that the use of a learned transformation and the iterative process can yield further improvements and are complementary to each other.

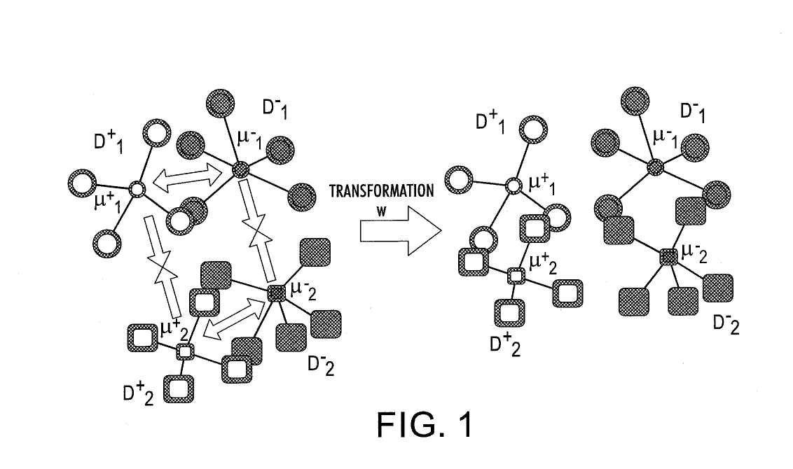

The exemplary metric learning involves learning a transformation of the feature space such that inter-class distances are decreased and intra-class distances are increased independently of the domain. This is illustrated FIG. 1 for two domains denoted D₁ and D₂, where μ₁⁺ and μ₁⁻ represent the means of samples from domain D₁ that are positive (resp. negative) for a given class, and μ₂⁺ and μ₂⁻ represent the means of samples from domain D₂ that are positive (resp. negative) for the given class. Prior to applying the transformation, the positive samples from the two domains are fairly distant from each other, but relatively close to the respective negative samples. After applying the transformation, the two positive sets of samples become closer, as illustrated by the shorter distance between their two means, and become further from the respective negative samples.

In the exemplary Self-Adaptive Metric Learning Domain Adaptation (SAMLDA) method disclosed herein, the available unlabeled target instances are exploited to adjust the learned transformation to the target domain. In one embodiment, the DSCM classifier is used to select and label unlabeled target instances to enrich the training set and also to select the more ambiguous labeled source examples to remove from the training set. This dynamically updated training set is used to actively refine the learned transformation by enabling the learning process to exploit the characteristics of the unlabeled target instances. While in one embodiment, the SAMLDA framework uses a Domain-Specific Nearest Class Means metric learning (DSCMML) approach, other metric learning approaches can be used in the active learning framework in order to improve the classification of the target instanced in the transformed space.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

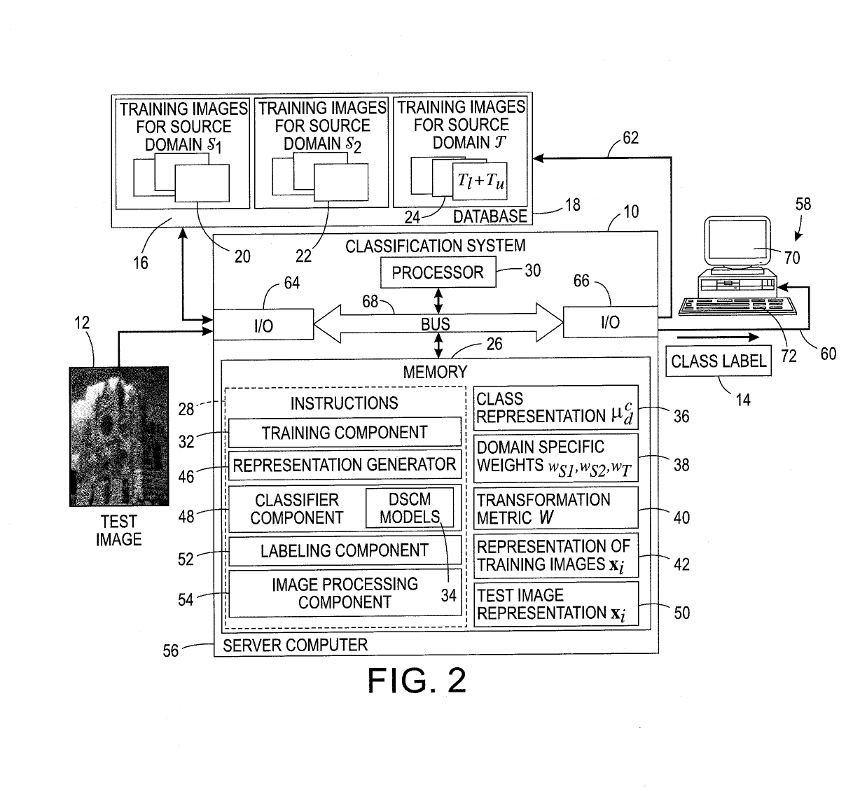

With reference to FIG. 2, an exemplary image classification system 10 is illustrated in an operating environment. The system takes as input a new sample 12 to be classified. The system 10 assigns a class label 14 or labels probabilistically to the sample 12, based on labels of a training set 16 of training samples stored in a database 18, which for each of a set of domains, contains a collection 20, 22, 24 of training samples. While three domains are illustrated, it will be appreciated that any number of domains may be considered. One or more of the domains is/are source domains for which the respective samples in the set 20, 22 are each labeled with a respective class label selected from a predefined set of class labels. One of the domains is a target domain for which at least some or all of the samples in the set 24 may be unlabeled, at least initially. The exemplary samples are images and will be described as such. By way of example, the image 12 may depict an object, such as a physical object, scene, landmark, or document.

The system 10 includes memory 26, which stores instructions 28 for performing the exemplary method, and a computer processor 30 communicatively linked to the memory 26, for executing the instructions. Memory 26 also receives and stores the sample image 12 during classification.

The instructions 28 include a training component 32 for learning a Domain-Specific Class Means (DSCM) classifier model 34, as discussed in greater detail below, for each of a set of classes. As part of the training process, for each of the domains d, the training component 32 computes a set 36 of class representations μ_{d}^{c}, one for each of the classes c in the set of classes, based on the labeled training samples 20, 22 (as well as labels for some of the unlabeled target domain samples 24, which may be generated in the learning process). Domain-specific weights w_{d} 38 are also learned or assigned by the training component 32. The training component may also learn a transformation metric 40, such as an n×m matrix W. This allows a distance to be computed between class and image representations 36, 42 which are embedded in (projected into) an m-dimensional space with the transformation metric 40. Each of the domain-specific class representations μ_{d}^{c} may be a function, such as the average (e.g., mean), of the set of n dimensional vectors representing the images 16 in the database 18 that are currently labeled with the corresponding class label (or at least a representative sample of these vectors) for that domain. The mean of a set of multidimensional vectors can be computed by averaging, for each dimension, the vector values for that dimension. In other embodiments, each domain-specific class representation 36 may be a set of two or more centroids (representative vectors), which collectively are representative of the class for that domain. As for the class mean, the centroids are derived from the set of n dimensional vectors representing the images 16 in the database 18 that are currently labeled with the corresponding class label (or at least a representative sample of these vectors) for that domain.

In some embodiments, m may be larger than n. However, it is to be appreciated that n could be equal to or larger than m. n and m can each be, for example, at least 5 or at least 10, and can be up to 1,000,000, such as at least 30, or at least 100, and in some embodiments, less than 100,000. The learning process may be an iterative one, as briefly noted above, in which the domain-specific class means are progressively refined, and the domain-specific weights 38 and/or transformation matrix 40 may also be refined.

As will be appreciated, once the classifier models 34 and optionally the weights 38 and metric 40 have been learned, the training component 32 may be omitted from the system, or the learned classifier models may be output to another computing device, e.g., using a transitory or non-transitory memory storage device or a network link. In other embodiments, the training component is used to update the parameters of the classifier models when new images are added to the training set and/or when new domains or classes are added.

Optionally, a representation generator 46 generates the multidimensional representations 42, 50, etc. of the images 16, 12 in the initial feature space, based on features extracted from the images, as described in further detail below.

A DSCM classifier component 48 predicts a class label 14 for the image 12 using the learned classifier models 34, based on the multidimensional representation 50. The classifier models can each be in the form of a classification function, which may include the domain-specific weights which are each used to weight a decreasing function of the computed distance between the representation 50 of the test image and respective domain-specific class representation (in the feature space projected by matrix W), in order to compute a probability that the image 12 should be labeled with a given class.

A labeling component 52 applies a label to the test sample 12, based on the classifier component output. An image processing component 54 may implement a computer implemented process, based on the applied label.

The computer-implemented classification system 10 may include one or more computing devices 56, such as a PC, such as a desktop, a laptop, palmtop computer, portable digital assistant (PDA), a server computer, cellular telephone, tablet computer, pager, combination thereof, or other computing device capable of executing instructions for performing the exemplary method. For example, the labeling may be performed on a server computer 56 and the labels output to a linked client device 58, or added to the database 18, which may be accessible to the system 10 and/or client device 58, via wired or wireless links 60, 62, such a local area network or a wide area network, such as the Internet. The computing device 56 includes one or more input/output interfaces (I/O) 64, 66 for communicating with external devices, such as client device 58 and/or database 18. Hardware components 26, 30, 64, 66 of the system may communicate via a data/control bus 68.

The memory 26 may represent any type of non-transitory computer readable medium such as random access memory (RAM), read only memory (ROM), magnetic disk or tape, optical disk, flash memory, holographic memory or combination thereof. In one embodiment, the memory 26 comprises a combination of random access memory and read only memory.

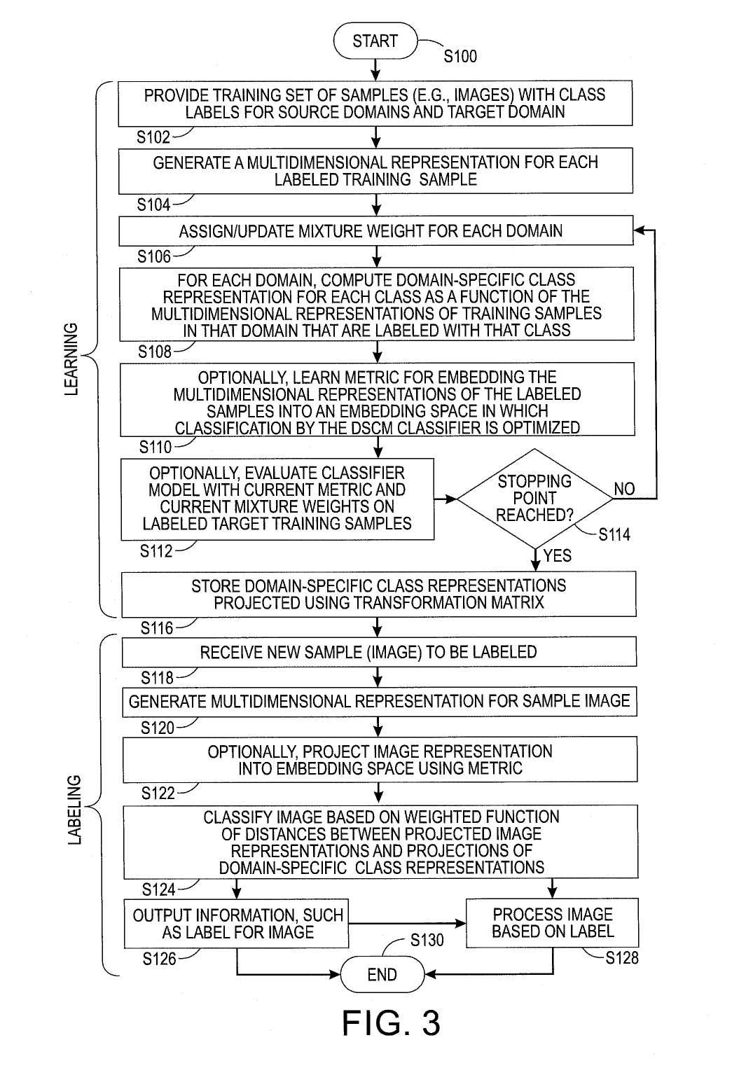

The digital processor 30 can be variously embodied, such as by a single-core processor, a dual-core processor (or more generally by a multiple-core processor), a digital processor and cooperating math coprocessor, a digital controller, or the like. The exemplary digital processor 30, in addition to controlling the operation of the computer system 10, executes the instructions 28 stored in memory 26 for performing the method outlined in FIG. 3.

The interface 64 is configured for receiving the test image 12 (or a pre-computed representation 50 thereof) and may include a modem linked to a wired or wireless network, a portable memory receiving component, such as a USB port, disk drive, or the like. The interface 66 may communicate with one or more of a display 70, for displaying information to users, such as images 12, labels 14, and/or a user input device 72, such as a keyboard or touch or writable screen, and/or a cursor control device, such as mouse, trackball, or the like, for inputting text and for communicating user input information and command selections to the processor 30. In some embodiments, the display 70 and user input device 72 may form a part of a client computing device 58 which is communicatively linked to the server computer 56 by a wired or wireless link, such as a local area network or wide area network, such as the Internet.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

The DSCM models 34 and exemplary learning methods will now be described in greater detail. By way of background, two types of classifier useful for assigning a probability to a sample of being in a given class which may be adapted for use herein will first be described. These are the nearest class mean (NCM) classifier and the Nearest Class Multiple Centroids (NCMC) classifier. These will be described briefly.

### The Nearest Class Mean (NCM) Classifier

Let xᵢ represent a sample, such as an image representation. For convenience xᵢ, may be referred to herein simply as an image. The Nearest Class Mean (NCM) classifier assigns xᵢ to the class c*∈Y_{c}={1, . . . , C} whose mean μ_{c} is the closest:

$${c}^{*} = arg {min}_{c ∈ {Y}_{c}} {d}_{W} ( {x}_{i} , {μ}^{c} ) , with \\ {μ}^{c} = \frac{1}{{N}^{c}} {\sum }_{i : {y}_{i} = c} {x}_{i} , \qquad ( 1 )$$

where yᵢ is the ground-truth class label of the image xᵢ and N^{c} is the number of training examples from the class c.

In one embodiment, the distance between the sample xᵢ and one of the class means μ^{c} in a projected feature space, denoted d_{W}(xᵢ,μ^{c})=∥W(xᵢ−μ^{c})∥², i.e., the distance is computed as the squared Euclidean distance between instance xᵢ and the class mean μ^{c} in some projected feature space given by the transformation matrix W. If W is the identity (I), this corresponds to the squared Euclidean distance in the original feature space. Eq. (1) can be reformulated as a multi-class softmax assignment using a mixture model (with equal weights), where the probability that an image xᵢ belongs to the class c is an exponential function of the distance in the projected feature space, which may be defined as follows:

$$p ( c \vert {x}_{i} ) = \frac{exp ( - \frac{1}{2} {d}_{W} ( {x}_{i} , {μ}^{c} ) )}{{\sum }_{{c}^{′} = 1}^{{N}_{C}} exp ( - \frac{1}{2} {d}_{W} ( {x}_{i} , {μ}^{{c}^{′}} ) )} . \qquad ( 2 )$$

where the denominator is a normalizing function which ensures that the posterior probabilities p(c|xᵢ) sum to unity, N_{C} is the number of classes and c′ is one of the c classes. The final assignment may be done by assigning the class with the highest probability value, according to Eq. (2), i.e., c*=argmax_{c∈Y}_{_{c}}p(c|xᵢ).

This probability definition may also be interpreted as the posterior probabilities of a Gaussian generative model p(xᵢ|c)= [symbol] (xᵢ,μ^{c},Σ) where [symbol] represents a set of Gaussian functions with the mean being μ^{c} and the class independent covariance matrix Σ, where Σ⁻¹=W^{T}W, and where T represents the transpose operator.

Once the distance metric d_{W} is known, learning the mean parameters of such a classifier is very efficient as it only involves summing the image descriptors for each class.

### The Nearest Class Multiple Centroids (NCMC) Classifier

The Nearest Class Multiple Centroids (NCMC) classifier extends the NCM classifier by representing each class by a set of centroids obtained by clustering images within each class. See, Mensink 2013 and U.S. Pub. No. 20140029839. Hence, the NCMC represents each class by a set of centroids {m_{c}^{j}}ⱼ₌₁^{k}, instead of a single class mean (NCM corresponds to k=1 and m_{c}¹=μ_{c}). The posterior probability for the class c can then be defined as a function of an aggregate (e.g., sum), over all the centroids for a given class, of the exponential function of the distance measure between the sample and the centroid, in the projected feature space, e.g., according to:

$$p ( c \vert {x}_{i} ) = \frac{1}{Z} {\sum }_{j = 1}^{k} exp ( - \frac{1}{2} {d}_{W} ( {x}_{i} , {m}_{c}^{j} ) ) , \qquad ( 3 )$$

where Z=Σ_{c}Σⱼ exp(−½d_{W}(x,m_{c}^{j})) is the normalizer. The set of k cluster means {m_{c}^{j}} of each class c can be obtained by clustering the instances within a class in general in the original feature space. The model for each class becomes an equal weighted Gaussian mixture distribution with m_{c}^{j} as means and (W^{T}W) being the shared inverse covariance matrix.

### Domain-Specific Class Means (DSCM) Classifier

The Domain-specific Class Means (DSCM) classifier 48 extends the approach used in the NCM and NCMC classifiers by considering domain-specific class representations, such as domain-specific class means 36. The DSCM classifier considers multiple domains where for each class, a domain-specific class mean is considered as representative of the class for that domain.

As discussed above, the domain-specific class mean for a given class c and a given domain d is denoted by μ_{d}^{c} and is a representation of a class which is a function of an aggregate of training samples representations labeled with that class c from a given domain d. The domain d is selected from a set [symbol] of two or more domains (one or more of which, in the exemplary embodiment may be a source domain and one may be the target domain). The domain-specific class mean μ_{d}^{c} for class c and domain d can be represented by the average of these training samples, as follows:

$${μ}_{d}^{c} = \frac{1}{{N}_{d}^{c}} {\sum }_{i : {y}_{i} = c , {x}_{i} ∈ {𝒟}_{d}} {x}_{i} , \qquad ( 4 )$$

where N_{d}^{c} is the number of images from class c in domain d. Thus only training samples labeled with class c that are from the specific domain d, and not from any of the other domains in the set of domains, are used in computing the respective domain-specific class mean. However, this restriction could be modified in some cases to allow a small percentage, such as less than 30% or less than 20%, or less than 10% of samples from other domains to be used in computing μ_{d}^{c}.

In the exemplary embodiment, the classifier model 34 assigns class c to a sample xᵢ according to the posterior of a mixture:

$$p ( c \vert {x}_{i} ) = \frac{{w}_{c} p ( {x}_{i} \vert c )}{{\sum }_{{c}^{′}} {w}_{{c}^{′}} p ( {x}_{i} \vert {c}^{′} )} \qquad ( 5 )$$

where the class-specific mixing weight w_{c} for each class can be manually set or learnt, or in one exemplary embodiment set to a constant (e.g., w_{c}=1/N_{c} for all classes c). The denominator Σ_{c′}w_{c′}p(xᵢ|c′) in Eq. (6) is a normalizer which sums, over all classes c′, the weighted probability for that class. p(xᵢ|c) can be expressed as a generative model, such as a Gaussian mixture model, where the probability for an image xᵢ to be generated by class c is given by a weighted Gaussian mixture distribution of D Gaussian functions, each corresponding to a domain-specific class set:

p(xᵢ|c)=Σ_{d=1}^{D}w_{d} [symbol] (xᵢ,μ_{d}^{c},Σ) (6)

employing the domain specific mixing weights w_{d} for each Gaussian function [symbol] , the domain-specific class means μ_{d}^{c} as the Gaussian means, and a class- and domain-independent inverse covariance matrix Σ⁻¹ which may be set such Σ⁻¹=(W^{T}W). The classifier model 34 in Eq. (5) can be then written as:

$$\begin{matrix}p ( c \vert {x}_{i} ) = \frac{{w}_{c} {\sum }_{d = 1}^{D} {w}_{d} exp ( - \frac{1}{2} {d}_{W} ( {x}_{i} , {μ}_{d}^{c} ) )}{{\sum }_{{c}^{′}} {w}_{{c}^{′}} {\sum }_{d = 1}^{D} {w}_{d} exp ( - \frac{1}{2} {d}_{W} ( {x}_{i} , {μ}_{d}^{{c}^{′}} ) )} \\ = \frac{1}{{z}_{i}} {w}_{c} {\sum }_{d = 1}^{D} {w}_{d} exp ( - \frac{1}{2} {d}_{W} ( {x}_{i} , {μ}_{d}^{c} ) )\end{matrix} \qquad ( 7 )$$

(or a function thereof), where the probability of assigning a class c to a sample xᵢ can be defined again as a function of the normalized distance in the projective space between the sample and the domain-specific class mean. In Eq. (7), the denominator Zᵢ(i.e., Zᵢ=Σ_{c′}w_{c′}Σ_{d=1}^{D}w_{d}exp(−½d_{W}(xᵢ,μ_{d}^{c′}) is a normalizing factor over all classes C, so that the posterior probabilities p(c|xᵢ) for all classes sum to 1, and may be optional in some cases. As will be appreciated, the value ½ in the exponent may be omitted and/or simply incorporated into the transformation matrix W. Also, if w_{c}=1/N_{c}, this value can be incorporated into the normalizing factor or ignored.

If W=I, the distances d_{W}(xᵢ,μ_{d}^{c}) in the DSCM classifier model are computed in the original feature space. The probability of assigning a class c to a feature vector xᵢ is thus a weighted exponentially decreasing function of the distance between the projected feature vector xᵢ and each projected domain-specific class mean, aggregated (e.g., summed) over all domain-specific class means for that class, and optionally normalized with a normalizing factor Zᵢ. In the exemplary embodiment, as for the NCM classifier, the distance metric is the norm of μ_{d}^{c}−xᵢ, such as the squared l₂ distance (Euclidean distance), when each of μ_{d}^{c} and xᵢ is projected by the projection matrix W, i.e.,

d_{W}(xᵢ,μ_{d}^{c})=∥W(xᵢ−μ_{d}^{c})∥²

Rather than using the squared Euclidean distance, some other suitable distance metric, such as the Mahalanobis distance, may be used to compute the distance in the projected feature space between xᵢ and μ_{d}^{c}.

It should be noted that when the distance measure is the squared Euclidean distance in the projected space:

d_{W}(xᵢ,μ_{d}^{c})=∥W(xᵢ−μ_{d}^{c})∥²=(μ_{d}^{c}−xᵢ)^{T}W^{T}W(μ_{d}^{c}−xᵢ)

where T represents the transpose. This allows p(c|xᵢ) to be readily computed by matrix multiplication.

The domain-specific weights w_{d} used in Eqs. (6) and (7) are used to express the relative importance of the different domains. These weights can be manually assigned (e.g., based on some prior knowledge about the source domains), learned (e.g., through cross validation) or deduced directly from the data. In one embodiment, the source domains may all be assigned a weight wₛ (e.g., an equal weight) which is less than the weight assigned to the target domain wₜ. In other embodiments the source domains may be manually or automatically accorded weights which reflect how well they model the target domain. Source domains which have less than a threshold computed weight may be dropped from consideration in the classifier model to reduce computation time.

Let [symbol] denote the target domain and [symbol] denote a set of source domains [symbol] ᵢ. One method for defining each source domain weight wₛ_{ᵢ} is to measure how well the source domain [symbol] ᵢ is aligned with the target domain [symbol] in the space projected by W. This can be performed, for example, by using Target Density Around Source (TDAS):

$$TDAS = \frac{1}{{N}_{s}} {\sum }_{{x}_{i}^{s} ∈ 𝒮} \vert {x}^{t} \vert {d}_{W} ( {x}^{t} , {x}_{i}^{s} ) \vert \leq ɛ \vert , \qquad ( 8 )$$

where Nₛ is the number of samples for a given source domain and E is a threshold. This method estimates the proportion of target domain samples for which the distance to at least one of the samples for the source domain is less than or equal to the threshold ε. ε may be set, for example, to half of the mean distance between the source sample and the nearest target sample. Given the computed TDAS for each source domain, domain weights wₛ_{ᵢ} can be assigned as a function of the TDAS, e.g., directly proportional thereto.

Alternatively, in a semi-supervised setting, where a small set of labeled samples is available from the target domain (denoted by [symbol] ₗ), the method may proceed as follows. The class means for each source domain [symbol] ᵢ are considered individually and used in an NCM classifier as exemplified in Eq. (2) to predict the labels for samples in [symbol] ₗ. The average classification accuracy of this classifier can be used directly as wₛ_{ᵢ}.

In the case of large datasets, Eq. (7) can be extended by considering a set of domain-specific prototypes for each class by clustering the N_{d}^{c} domain-specific images from class c and domain d. This set of centroids can then be considered as representative of a class for a given domain in a similar manner to the NCMC classifier discussed above.

In another embodiment, domain- and class-specific weights w_{d}^{c} are used in Eq. (7), where both the TDAS measure and the NCM accuracy can be easily computed for each class individually. In this, case w_{c} can be absorbed by w_{d}^{c}.

As will be appreciated, the exponential function exp in Eq. (6) can be replaced by another suitable decreasing function whereby its value decreases as the distance (in the projected feature space) between μ_{d}^{c} and xᵢ increases, such as a linearly decreasing function.

The trained DSCM classifier component can output class probabilities based on (e.g., equal to) the values p(c|xᵢ) according to Eq. (5), for each class in C, or for at least a subset of the classes, such as those which exceed a predetermined threshold probability p. In another embodiment, the classifier component 42 outputs the single most probable class c* (or a subset N of the most probable classes, where N<N_{C}). For example, a new image xᵢ can be assigned to the class c* with highest probability, e.g., as follows:

$${c}^{*} = {arg min}_{c ∈ C} \frac{1}{{z}_{i}} {w}_{c} {\sum }_{d = 1}^{D} {w}_{d} exp ( - \frac{1}{2} {d}_{W} ( {x}_{i} , {μ}_{d}^{c} ) )$$

### Metric Learning for DSCM (DSCM-ML)

In one embodiment, the parameters of the classifier model 34, such as the metric (transformation matrix) W and optionally the domain weights w_{d}, are learned automatically or semi-automatically. The exemplary metric learning method aims to find a transformation metric W, such that the log-likelihood of the correct predictions are maximized on the training set Xᵣ. This can be expressed as follows:

[symbol]

=Σₓ_{ᵢ}_{∈X}_{ᵣ} ln p(c=yᵢ|xᵢ)=Σₓ_{ᵢ}_{∈X}_{ᵣ}[ln w_{y}_{ᵢ}Σ_{d}g_{i,d}^{y}^{ᵢ}−ln Σ_{c′}w_{c′}Σ_{d}g_{i,d}^{c′}] (9)

where g_{i,d}^{y}^{ᵢ}=w_{d}exp(−½d_{W}(xᵢ,μ_{d}^{y}^{ᵢ})), g_{i,d}^{c′}=w_{d}exp(−½ d_{W}(xᵢ,μ_{d}^{c′})) and c′ represents a class from C other than the considered class c.

The goal of the training is to find the projection matrix W that maximizes the likelihood function [symbol] . To compute the projection matrix W that optimizes this function over a large training set may be computationally expensive or intractable. Accordingly, optimization can be achieved by using an iterative process, such as a gradient descent learning method. The gradient descent method may be a single or mini-batch stochastic gradient descend (SGD) method using a learning rate (η). In one embodiment the learning rate (η) is fixed throughout the training. In a mini-batch process, at each iteration, only a small fraction (batch) X_{b}∈X of the training data, is randomly sampled (in the single case, only one sample is used). W is updated with the gradient by determining whether the current projection matrix applied to Eq. (5) labels them correctly according to their ground truth, i.e., with their actual (correct) labels, and otherwise updates the projection matrix W. The gradient of the objective function shown in Eqn. (9) can be shown to have the form:

$${∇}_{W} {ℒ}_{r} = {\sum }_{{x}_{i} ∈ {X}_{r}} [ {\sum }_{{c}^{′}} {w}_{{c}^{′}} {\sum }_{d} ( \frac{{g}_{i , d}^{{c}^{′}}}{{Z}_{i}} - [ [ {c}^{′} = {y}_{i} ] ] \frac{{g}_{i , d}^{{y}_{i}}}{{\sum }_{{d}^{′}} {g}_{i , {d}^{′}}^{{y}_{i}}} ) W ( {μ}_{d}^{{c}^{′}} - {x}_{i} ) {( {μ}_{d}^{{c}^{′}} - {x}_{i} )}^{T} ]$$

where r represents one of a set of iterations, [symbol] ᵣ denotes the log likelihood over the samples in iteration r, [[c′=yᵢ]] is one if its argument is true and zero otherwise, and yᵢ is the ground-truth class label of the image xᵢ.

The projection matrix W to be learned is initialized with a set of values. In one embodiment, W may be initialized with principal component analysis, keeping the number of eigenvectors corresponding to the dimension of the projected space (generally smaller than the initial feature space). In other embodiments, the initial values can be selected arbitrary. For example, the initial values in the matrix are drawn at random from a normalized distribution with a mean of 0, i.e., the values sum to 0 in expectation. In other embodiments, the initial values are drawn from a projection matrix previously created for another classification task.

The update rule for the projection matrix using stochastic gradient descent can be a function of the prior projection matrix at iteration r and the learning rate, for example, as follows:

Wᵣ₊₁=Wᵣ−η∇_{W} [symbol] ᵣ

where [symbol] ᵣ denotes the log likelihood over the samples in iteration r, and η is a constant or decreasing learning rate that controls the strength of the update. In one exemplary embodiment, η is a constant and has a value of less than 0.1, such as about 0.01. This updates each of the values in the projection by a small amount as a function of the learning rate. Several projection matrices can be learned, with different values of m, and tested on the validation set to identify a suitable value of m which provides acceptable performance without entailing too high of a computational cost at labeling time.

### Self-Adaptive Metric Learning for Domain Adaptation (SAMLDA)

The domain adaptation (DA) method can use unsupervised or semi-supervised learning. Unsupervised DA refers to the case where no labeled data is available from the target domain and semi-supervised DA to the case where there are a few labeled images from the target domain to guide the learning process.

Let Tₗ denote the set of labeled target samples (that can initially be empty) and let Tᵤ denote the set of unlabeled target samples in the training set. Let S₁, . . . , S_{N}_{_{S}} denote N_{S} source domains and Xᵣ a current training set containing labeled instances xᵢ (that can be ground truth labels or predicted ones) from different source domains. Let Y_{c} denote the set of class labels, and Y_{d}={s₁, . . . s_{N}_{_{S}}, sₜ} the set of domain-related labels, where sₜ refers to the target domain. Let w_{d}=(wₛ_{₁}, . . . , wₜ) be the set of domain-specific weights.

In the exemplary self-adaptive metric learning domain adaptation (SAMLDA) method, at each of a plurality of iterations, one or more unlabeled target images from the target domain are added to the training set Xᵣ and/or one or more images from the source set(s) are removed, to refine W. This method assumes a metric learning component f_{W}(Xᵣ,Wᵣ,W_{d}^{r}), as part of the training component 32, that receives as input an initial transformation Wᵣ, a set of labeled training instances Xᵣ and optionally a set of domain-specific weights w_{d}^{r}. Then, using either only the class labels Y, or also the domain-related labels Y_{d} of the instances in Xᵣ, the metric learning component outputs an updated transformation Wᵣ₊₁=f_{W}(Xᵣ,Wᵣ,w_{d}^{r}).

While the DSCM-ML method using iterative gradient described above is one particular example of a metric learning component f_{W}(Xᵣ,Wᵣ,w_{d}^{r}) which may be used herein, the method can use any other metric learning approach. Indeed, in the case of metric learning methods not designed to handle multiple source domains, the domain-related labels Y_{d} and weights w_{d} are simply ignored by f_{W}.

An exemplary self-adaptive metric learning based domain adaptation algorithm suitable for performing the learning is illustrated in Algorithm 1.

Algorithm 1: SAMLDA Learning Method

```
Require: The initial training set X₀ = {S₁, ..., S_{N}_{S}, Tₗ}.
Require: Domain-specific weights w_{d}⁰ and an initial transformation W₀.
Ensure: A metric learning component f_{w}.
1: Get W₁ = f_{w}(X₀, W₀, w_{d}⁰).
2: for r = 1, ..., N_{R} do
3:  set Xᵣ = Xᵣ₋₁.Compute domain-specific class means μ_{d}^{c} in Xᵣ
4:  Set w_{d}^{r} = w_{d}^{r-1}. Optionally, update weights, e.g., using TDAS or
NCM with Wᵣ
5:  For each xᵢ ∈ Xᵣ₋₁ and each class cⱼ compute p(cⱼ|xᵢ) using
        Eq. (7) with Wᵣ.
6:  For each class cⱼ, add xᵢ^{t} ∈ Tᵤ to Xᵣ for which
        p(c*|xᵢ^{t) - p (c}^{†}|xᵢ^{t}) is the largest.
7:  For each class cⱼ, remove xⱼ^{s} ∈ Xᵣ₋₁\Tₗ from Xᵣ for which
        p(c*|xⱼ^{s}) − p(c^{†}|xⱼ^{s}) is the smallest.
8:  Set Wᵣ₊₁ = f_{w}(Xᵣ, Wᵣ, w_{d}^{r}).
9:  If stopping criteria is met (classification accuracy degraded or
        no more data available to add or remove), quit the loop.
10: end for
11: Output Wᵣ* where r* + 1 is the iteration at stopping criteria
    (or r* = N_{R}).
```

The exemplary algorithm takes as input the initial training set Xᵣ=X₀. This includes the labeled samples for the source domains and the sets of labeled samples S₁, . . . , S_{N}_{_{S}} for the source domains and the set of labeled samples Tₗ for the target domain. An initial set of domain-specific weights w_{d}^{r}=w_{d}⁰ and an initial transformation W₀ are also received. A metric learning component f_{W}(Xᵣ,Wᵣ,w_{d}^{r}) is also provided, such as one which implements an iterative stochastic gradient descent method for optimizing the log likelihood of Eq. 9.

Using the initial labeled set X₁ (all source samples and labeled target samples, if available), at step 1 of the algorithm, a new projection matrix W₁=f_{W}(X₀,W₀,w_{d}⁰) is computed as a function of the current training set, initial projection matrix and initial set of weights. The initial W₀ may be obtained using the first PCA directions of the training set X₀. An advantage of the dimensionality reduction is that there are fewer parameters to learn, which is especially useful when only a relatively small number of training examples is available; it also generally leads to a better performance. The DSCM-ML method using iterative gradient descent, described above, may be used as the method f_{W} to compute the first projection matrix W₁.

In the following steps (2-10 of the algorithm, which may be repeated R times or until some other stopping criterion is met), W is iteratively refined by, at each iteration, at least one of: a) adding to the current training set Xᵣ unlabeled images from the target samples with their predicted class labels (step 6); and b) removing the less confident source samples (step 7), resulting in the source data being better clustered around the domain-specific class means. This is similar to the method used in Tommasi, T., et al., “Frustratingly easy NBNN domain adaptation,” IEEE Int'l Conf. on Computer Vision (ICCV), pp. 897-904 (2013). However, rather than selecting images to be added or removed based on the distances between low-level features (image-to-class distance in Tommasi is computed as a sum of distances between low level features extracted from the image and its closest low level feature within a class), the exemplary method makes use of the DSCM class probabilities, defined in Eq. 7 for refining the training set Xᵣ.

At step 3 of the algorithm, the domain-specific class means μ_{d}^{c} are computed (recomputed, e.g. using Eq. 4) for each class for each domain, using the training samples currently in the training set Xᵣ=Xᵣ₋₁, updated based on samples added and/or removed in the last iteration.

At step 4, the domain-specific weights w_{d}^{r} are set to w_{d}^{r-1}. Optionally, they are updated using a suitable update method. Where an initial set of labeled samples in the target domain is available, this step may include using an NCM classifier as exemplified in Eq. (2) for each domain to predict the labels for the labeled samples in [symbol] ₗ. In computing the class predictions, the current transformation matrix Wᵣ may be used for embedding the domain samples and class means in the projected space. The average classification accuracy of this classifier can be used directly as the respective new domain-specific weight w_{d}^{r} or otherwise used to compute an update for the weight. Alternatively, TDAS or another method for updating weights may be employed.

At step 5, Eqn. (7) is used to compute the class probabilities for each of the samples in the current training set using the domain-specific class means μ_{d}^{c} computed at step 3.

At step 6, for each class cⱼ, a new unlabeled target sample xᵢ^{t}∈Tᵤ is added to the current training set Xᵣ. This added target sample is the one for which the difference (p(c*|xᵢ^{t})−p(c^{†}|x^{t}ᵢ)) between the class probability (as computed by the current classifier model) for the class c* and the class probability for the class c^{†} with the second highest class probability is the largest, where c*=cⱼ is the predicted label of x^{t}ᵢ and p(c^{†}|xᵢ^{t}) is the second largest probability score for sample x^{t}ᵢ. It may be noted that as Σⱼ₌₁^{C}p(cⱼ|x^{t}ᵢ)=1, the selected samples (e.g., images) are those for which the current classifier model is the most confident about the class prediction c* although it does not necessarily mean that the label is correct.

Similarly, at step 7, for each class, one of the source domain samples is removed from the current training set Xᵣ (excluding Tₗ). This is the source sample for which the difference (p(c*|xⱼ^{s})−p(c^{†}|x^{s}ⱼ)) between its class probability and that of the class with the second highest probability is the smallest, i.e., the classifier considers it to be the most ambiguous example. In the exemplary embodiment, only one sample per class is selected for removal from the current training set Xᵣ, but in other embodiments fewer or more samples could be selected for removal, for example, for each class, a sample could be removed per source domain.

At step 8, the transformation matrix is updated. As for step 1, Wᵣ₊₁=f_{W}(Xᵣ,Wᵣ,w_{d}^{r}) is computed, using, for example, the DSCM-ML method using iterative gradient descent, described above. This adds a second iterative loop within the main loop.

Steps 3-8 may be iterated until no more target data can be added or source data can be removed or until the maximum number R of iterations is achieved. However, adding target samples as training samples with predicted labels comes with the risk of adding noise (incorrect labels). Therefore another stopping criterion may be added, as follows. At each iteration, the classification accuracy of the learned DSCM classifier on the original labeled set [symbol] ₗ is evaluated and if the classification performance in step r+1 incurs a stronger degradation than a predefined tolerance threshold (e.g., 1%) compared to the accuracy obtained in step r, iterating is stopped and Wᵣ, the metric obtained before degradation, is retained. As will be appreciated, other stopping criteria can also be considered, such as measuring the variation between iterations of the TDAS.

With reference now to FIG. 3, a method for training and using a classifier model to label samples 12, such as images, is illustrated, which can be performed using Algorithm 1, although other methods for assigning weights and the option of not using a transformation matrix W are also contemplated (equivalent to W=I, identity). The method may be performed with the system of FIG. 2. The method includes a learning phase and a run (labeling) phase in which the classifier is used in labeling unlabeled samples 12. The method begins at S100.

At S102, training samples are provided. The training samples include a set of target samples in the target domain, some of which may have been manually-assigned a respective class label, and for each of at least one or two source domains, a set of labeled source samples. The labels for the source samples and target domain training samples are selected from the same predefined set of at least two class labels.

At S104, a multidimensional representation 42 (n-dimensional vector) is computed for each of the training samples (by the representation generator 46), in the original feature space, if this has not already been done.

At S106, for each domain (including the source domain(s) and target domain), a weight is assigned, which may take into account how well that domain performs in terms of predicting class labels for target domain samples. In an iterative process, such as using Algorithm 1, the weights may be subsequently updated based on the classification accuracy of the current classifier model. In another embodiment, weights may be manually or otherwise assigned, giving the target domain a higher weight than each of the source domain(s), for example, where a ratio of the target domain weight to each of the source domain weights is at least 1.2:1 or at least 1.5:1.

At S108, for each domain (including the source domains and target domain), and for each class in the set of classes, a domain-specific class representation 36 is computed (by the training component 32) as a function of the multidimensional representations 42 of the samples in that domain that are labeled with that class, e.g., by averaging the multidimensional representations 42 of all or at least a subset of the training samples 20, 22, or 24 labeled with that class. The exemplary domain-specific class representation 36 is a domain-specific class mean (DSCM), computed as described above. In an iterative process, each DSCM may be subsequently updated after adding and/or removing samples from the class.

At S110, a transformation matrix 40 is optionally learned (by the training component 32), based on the set of training sample representations, their corresponding class labels, and the computed domain-specific class representations 36. The transformation matrix which is learned is one which when applied to the test sample representation 12, in an input subspace, embeds the representation in a new subspace, which enhances the probability that the DSCM classifier component 48 will correctly label the sample using the learned models 34. The learning step may be an iterative process as illustrated in Algorithm 1 in which the transformation matrix is updated to make the source domain samples in the training set better predictors of the target sample label. However, other machine learning methods are also contemplated.

In an illustrative embodiment, the learning includes computing class probabilities for each training image using a current classifier model (Eq. (7)) that includes a current value for each of the weights and a current transformation matrix. Unlabeled training samples from the target set can be added to classes for which their class probabilities are high, and labeled source training samples can be removed from the training set if their computed class probability is ambiguous. The transformation matrix is then updated as a function of the current transformation matrix, the current training set, and the current domain-specific weights. The current weights may then be updated. At S114, if a stopping point criterion is not met, the method may return to S106 or S108 for a further iteration.

The parameters of the classifier models 34, including the final transformation matrix 40 and current domain-specific weights 38, may be stored in memory 26. Fewer than all the source domains may be used in the final models 34. For example, source domains for which the computed weights are lower than a threshold value may be omitted (or only the source domains with the N best weights may be retained). The result the learning is a classifier model which includes the learned transformation matrix 40 which can be used for embedding sample representations 50 into a subspace suitable for computing class probabilities with the learned domain-specific weights by the DSCM method.

Once the transformation matrix 40 has been learned, current values of the DSCMs 36, projected with the learned transformation matrix, may be stored (S116) for speeding up the computation when labeling a new sample.

At S118, an unlabeled new sample 12 is received by the system 10. For example, a graphical user interface is generated for display on the display device 70 whereby a user can select an image 12 to be used as the test sample. The new sample 12 may be selected from a collection of images stored on the user's computing device 58 or from a remotely stored collection, such as database 18. In other embodiments, the system 10 automatically accesses a database at intervals to identify unlabeled images or is automatically fed new unlabeled images as they are received. In the exemplary embodiment, the image 12 is not among the images 16 used in training, although in other embodiments, this situation is not excluded, for example, if the labels of the database images are considered to contain some errors.

At S120, a multidimensional image representation 50 is computed for the input image 12, by the representation generator 46.

At S122, a projected image representation may be computed, by applying the learned transformation matrix 40 to the image representation 50 computed at S120.

At S124, the classifier component 48 computes a class or assigns probabilities to the classes for the new sample image 12 as function, over all domains, of the computed comparison measure (distances or similarity) between the projected image representation and the respective domain-specific projected class representation 36 and weight for that domain. For example, a class score for each class is computed as a function of an aggregation of a weighted decreasing function of the distance from the sample representation to each DSCM (in the projected space), e.g., using Eq. (6). In other embodiments, where a transformation matrix is not learned, distances can be computed in the original feature space.

As will be appreciated from the foregoing description, S122 and S124 can be combined into a single classification step in which a classification function such as Eq. (6) applies the learned transformation matrix 40 to the test sample representation 50 and the domain-specific class means 36.

At S126, a label for the image 12, or other information, may be output by the labeling component 54, based on the output of the classifier component at S124, such as the class with the highest computed class probability. In some embodiments, a test may be performed to determine whether the computed probability for the most probable class meets or exceeds a predetermined threshold value. If it does not, which indicates that the classifier component 48 is not able to identify any class with sufficient certainty, the image may be assigned none of the class labels and may be given a label corresponding to “unknown class.” If the computed probability at least meets the threshold, then the most probable class label 14 may be associated with the image 12. The label may be output from the system and linked to the image in some manner, such as with a tag, or stored in a record in which images are indexed by their labels. In some embodiments, the image 12 and its label 14 may be sent to the client device for validation by a person.

In some embodiments, the image and its label (optionally after human validation) may be added to the database 18. In some embodiments, the method may return to the training phase where new domain-specific class means may be computed, to reflect the newly added member 12 of the class corresponding to the label 14.

In some embodiments, at S128, a process may be implemented automatically, based on the assigned label. For example, if one or more of the classes relate to people of interest, and the label 14 is for a person who is of interest, the image 12 may be forwarded to the client device 58, where a user may view the image on an associated display 70 to confirm that the person has been correctly identified, and/or an automated process implemented, depending on the application. For example, the method may be used in airport screening, in identifying company individuals or named guests photographed, for example, at an event, in identifying the names of “friends” on a social media website, or the like. In another embodiment, if the image 12 contains alphanumeric characters, such as a form, scanned mail item, license plate image, or the like, the sample image 12 may be sent by the processing component 54 to an appropriate business unit designated for dealing with the type of text item corresponding to the class, and/or may be further processed, such as with OCR, or the like.

The method ends at S130.

The method illustrated in FIG. 3 may be implemented in a non-transitory computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIG. 3, can be used to implement the exemplary learning and or labeling method.

In summary, the DSCM classifier 48 is learned with samples 20, 22, 24 from both source and target domains, where each class c is modeled, as illustrated, for example, in Eq. (6), as a mixture of components (each component being a weighted exponentially decreasing function of the distance between the sample and a domain-specific class mean). There is one mixture component for each source domain and one for the target domain. The mean for each component is the average of the corresponding training samples. There is one mixture weight per source domain and one for the target domain, which allows the relative importance of a domain to be captured by the corresponding weight. The inference may be performed by computing the max of the class posteriors, e.g., according to Eq. (7), where the mixture components are Gaussians and the inverse of their covariance is shared and approximated by a low-rank matrix, e.g., using the illustrated metric-learning formulation.

A semi-supervised approach to learning a metric W for such a model from source and target data can include iteratively: adding to an active training set the most confident unlabeled target sample(s) for each class, removing from the active training set the least confident source sample(s) from each class, retraining a metric from the active training set, where the confidence used to remove/add samples is based on a classifier model that includes the learned metric, where each class is modeled as a mixture of components, and there is one mixture component for each source domain and one for the target domain.

Further illustrative examples of aspects of the system and method will now be described.

### Samples

In the case of images, the samples 12, 16 may be received by the system 10 in any convenient file format, such as JPEG, GIF, JBIG, BMP, TIFF, or the like or other common file format used for images and which may optionally be converted to another suitable format prior to processing. The image 12 can be input from any suitable image source 58, such as a workstation, database, memory storage device, such as a disk, or the like. The images 12, 20, 22, 24 may be individual images, such as photographs, scanned images, video images, or combined images which include photographs along with text, and/or graphics, or the like. In general, each input digital image includes image data for an array of pixels forming the image. The image data may include colorant values, such as grayscale values, for each of a set of color separations, such as L*a*b* or RGB, or be expressed in another other color space in which different colors can be represented. In general, “grayscale” refers to the optical density value of any single color channel, however expressed (L*a*b*, RGB, YCbCr, etc.). The word “color” is used to refer to any aspect of color which may be specified, including, but not limited to, absolute color values, such as hue, chroma, and lightness, and relative color values, such as differences in hue, chroma, and lightness.

Other types of samples are also considered, such as documents, which may include a sequence of characters that can be identified, e.g., as words, from which a representation may be generated based on word frequencies.

Each of the source domain training samples 20, 22 and optionally some (but not all) of the target domain training samples 24 is labeled with one (or more) class labels selected from a predetermined set of class labels, which may have been manually applied to the training samples, or, in some embodiments, some of the labels may have been automatically applied, e.g., using trained classifiers, such as one for each class. To improve performance, each training sample 20, 22, 24 generally has no more than a single label. The label may be in the form of a tag, such as an XML tag, or stored in a separate file. Each label corresponds to a respective class from a finite set of classes. There may be a large number of classes such as at least 20, or at least 50, or at least 100, or at least 1000 classes, and up to 10,000 or more classes, depending on the application and the availability of training data. The same number or a modified set of classes may be used in the classification (labeling) stage. For each class, for each domain, there is a set of samples labeled with that class. For example, there may be at least 5, or at least 10, or at least 100, or at least 1000 training samples for each class per domain. Each domain-specific class representation is thus generated from at least 5, or at least 10, or at least 100, or at least 1000 labeled samples. There is no need for each class to include the same number of samples. The class labels for training may be selected according to the particular application of interest. For example, if the aim is to find images of specific buildings, there may be class labels for different types of buildings, such as monuments, towers, houses, civic buildings, bridges, office buildings, and the like.

The transformation matrix 40 can be used over all classes, both existing and new ones. In general, the transformation matrix 40 comprises a matrix which, when applied to a sample representation 42, 50 and domain-specific class representations 36 (or set of centroids m_{cj}), each in the form of a multidimensional vector, converts the respective representation to a new “embedded” representation in a new multidimensional space which is a multidimensional vector of typically fewer dimensions than that of the input representation, a process referred to herein as embedding. In general, the embedding is the result of multiplying the respective vector 42, 50 by the matrix 40. In other embodiments, an objective function may be used as the transformation metric in place of a matrix.

### Representation Generation

The representation generator 46 may be any suitable component for generating a representation (or “signature”) 42, 50, such as a multidimensional vector, for the samples 12, 20, 22, 24 if their signatures have not been pre-computed. In the case of images as samples, various methods are available for computing image signatures. In general, the representation generator 46 generates a statistical representation 42, 50 of low level features extracted from the respective image, such as visual features (color, gradient, or the like) or, in the case of text samples, features based on word frequencies can be employed.

Exemplary methods for generating image representations (image signatures) are described, for example, in U.S. Pub. Nos. 20030021481; 2007005356; 20070258648; 20080069456; 20080240572; 20080317358; 20090144033; 20100040285; 20100092084; 20100098343; 20100226564; 20100191743; 20100189354; 20100318477; 20110040711; 20110026831; 20110052063; 20110091105; 20120045134; and 20120076401, the disclosures of which are incorporated herein by reference in their entireties.

For example, the image representation generated by the representation generator for each image 12, 20, 22, 24 can be any suitable high level statistical representation of the image, such as a multidimensional vector generated based on features extracted from the image. Fisher Kernel representations and Bag-of-Visual-Word representations are exemplary of suitable high-level statistical representations which can be used herein as an image representation.

For example, the representation generator 46 includes a patch extractor, which extracts and analyzes low level visual features of patches of the image, such as shape, texture, or color features, or the like. The patches can be obtained by image segmentation, by applying specific interest point detectors, by considering a regular grid, or simply by the random sampling of image patches. In the exemplary embodiment, the patches are extracted on a regular grid, optionally at multiple scales, over the entire image, or at least a part or a majority of the image. 50 or more patches may be extracted per image.

The extracted low level features (in the form of a local descriptor, such as a vector or histogram) from each patch can be concatenated and optionally reduced in dimensionality, to form a features vector which serves as the global image signature. In other approaches, the local descriptors of the patches of an image are assigned to clusters. For example, a visual vocabulary is previously obtained by clustering local descriptors extracted from training images, using for instance K-means clustering analysis. Each patch vector is then assigned to a nearest cluster and a histogram of the assignments can be generated. In other approaches, a probabilistic framework is employed. For example, it is assumed that there exists an underlying generative model, such as a Gaussian Mixture Model (GMM), from which all the local descriptors are emitted. Each patch can thus be characterized by a vector of weights, one weight for each of the Gaussian functions forming the mixture model. In this case, the visual vocabulary can be estimated using the Expectation-Maximization (EM) algorithm. In either case, each visual word in the vocabulary corresponds to a grouping of typical low-level features. The visual words may each correspond (approximately) to a mid-level image feature such as a type of visual (rather than digital) object (e.g., ball or sphere, rod or shaft, flower, autumn leaves, etc.), characteristic background (e.g., starlit sky, blue sky, grass field, snow, beach, etc.), or the like. Given an image to be assigned a representation, each extracted local descriptor is assigned to its closest visual word in the previously trained vocabulary or to all visual words in a probabilistic manner in the case of a stochastic model. A histogram is computed by accumulating the occurrences of each visual word. The histogram can serve as the image representation or input to a generative model which outputs an image representation based thereon.

As local descriptors extracted from the patches, SIFT descriptors or other gradient-based feature descriptors, can be used. See, e.g., Lowe, “Distinctive image features from scale-invariant keypoints,” IJCV vol. 60 (2004). In one illustrative example employing SIFT features, the features are extracted from 32×32 pixel patches on regular grids (every 16 pixels) at five scales, using 128-dimensional SIFT descriptors. Other suitable local descriptors which can be extracted include simple 96-dimensional color features in which a patch is subdivided into 4×4 sub-regions and in each sub-region the mean and standard deviation are computed for the three channels (R, G and B). These are merely illustrative examples, and additional and/or other features can be used. The number of features in each local descriptor is optionally reduced, e.g., to 64 dimensions, using Principal Component Analysis (PCA). Signatures can be computed for two or more regions of the image and aggregated, e.g., concatenated.

In some illustrative examples, a Fisher vector (or Fisher kernel) is computed for the image by modeling the extracted local descriptors of the image using a mixture model to generate a corresponding image vector having vector elements that are indicative of parameters of mixture model components of the mixture model representing the extracted local descriptors of the image. The exemplary mixture model is a Gaussian mixture model (GMM) comprising a set of Gaussian functions (Gaussians) to which weights are assigned in the parameter training. Each Gaussian is represented by its mean vector, and covariance matrix. It can be assumed that the covariance matrices are diagonal. See, e.g., Perronnin, et al., “Fisher kernels on visual vocabularies for image categorization” in CVPR (2007). Methods for computing Fisher vectors are more fully described in U.S. Pub Nos. 20120076401 and 20120045134, and in Florent Perronnin, et al., “Improving the fisher kernel for large-scale image classification,” ECCV: Part IV, pp. 143-156 (2010), and in Jorge Sanchez et al., “High-dimensional signature compression for large-scale image classification,” in CVPR 2011, the disclosures of which are incorporated herein by reference in their entireties. The trained GMM is intended to describe the content of any image within a range of interest (for example, any color photograph if the range of interest is color photographs).

In other illustrative examples, a Bag-of-Visual-word (BOV) representation of an image is used as the original image representation. In this case, the image is described by a histogram of quantized local features. (See, for example, U.S. Pub. No. 20080069456, the disclosure of which is incorporated herein by reference in its entirety). More precisely, given an (unordered) set of the local descriptors, such as set of SIFT descriptors or color descriptors extracted from a training or test image, a BOV histogram is computed for the image or regions of the image. These region-level representations can then be concatenated or otherwise aggregated to form an image representation (e.g., one for SIFT features and one for color features). The SIFT and color image representations can be aggregated to form the image signature.

### Example Uses of the DSCM Classifier

In one illustrative example, the classifier 48 may be used in an evaluation of paper document printing, for example, to be able to propose electronic solutions to replace paper-workflows, thus optimizing the overall process and reducing paper consumption at the same time. Paper document content analytics is conventionally performed in a completely manual fashion, through surveys and interviews, directly with the customers and their employees. In U.S. Pub. No. 20140247461, a method is described for partially automating this process by using machine learning techniques. The method enables automatic analyses of printed documents content to cluster and classify the documents. A relatively large set of manually-labeled documents is needed for training, however. Since manual labeling is a costly operation, it would be beneficial to be able to use data from other domains. For example, the present domain adaptation method could be employed, using a current customer's data as the target domain and available document image datasets or labeled data from other customers as source domain data to learn classifier for the current customer.

Domain adaptation can also be useful in transportation where due to capturing conditions (daylight vs. night, inside parking vs. outside parking, camera and viewpoint changes) may lead to data sources with domain shift. These conditions can strongly affect the distribution of image features and thus violate the assumptions of the classifier trained on source domains. Again domain adaptation can be used to reduce the amount of manual labeling needed for each condition, by exploiting the labeled data already available for other conditions.

Without intending to limit the scope of the exemplary embodiment, the following examples demonstrate the application of the method to image classification.

### EXAMPLES

### Datasets

The following datasets were used to test the method, ICDA1 and ICDA2 from the ImageClef Domain Adaptation Challenge (http://www.imageclef.org/2014/adaptation). ICDA2 denotes the dataset that was used in the challenge to submit the results and ICDA1 the set of image representations provided in the first phase of the challenge. (The ImageClef Domain Adaptation Challenge had two phases where in the first phase the participants were provided with a similar configuration as in the submission phase, but with different image representations). The datasets consist of a set of image representations extracted by the organizers on randomly selected images from five different image collections. The image representations are a concatenation of four bag-of-visual word (BOV) representations (using the method of Csurka, G., et al., “Visual categorization with bags of keypoints,” ECCV Workshop on Statistical Learning in Computer Vision (2004)) built on a 2×2 split of the image, where the low level features were SIFT descriptors extracted densely from the patches of the corresponding image regions.

The five image collections were: Caltech-256 available at www.vision.caltech.edu/Image_Datasets/Caltech256/, Imagenet Large Scale Visual Recognition Challenge 2012 (ILSVRC2012) available at image-net.org/challenges/LSVRC/2012/, Pascal2 Visual Object Classes Challenge 2012 (PASCAL VOC2012), available at pascallin.ecs.soton.ac.uk/challenges/VOC/voc2012/index.html, the dataset used in Alessandro Bergamo, Lorenzo Torresani, “Exploiting weakly-labeled Web images to improve object classification: a domain adaptation approach,” (BING) available at vlg.cs.dartmouth.edu/projects/domainadapt/, and the SUN database available at groups.csail.mit.edu/vision/SUN/. These databases are denoted by C, I, P, B and S, respectively, for convenience. The organizers of the ImageClef challenge selected 12 common classes present in each of the datasets, namely, airplane, bike, bird, boat, bottle, bus, car, dog, horse, monitor, motorbike, and people.

In the present evaluation, four collections from the list (C, I, P and B) were used as source domains and for each of them, 600 image representations and the corresponding labels were provided. The SUN dataset served as the target domain, with 60 annotated and 600 non-annotated samples. The task was to provide predictions for the non-annotated target samples. Neither the images nor the low-level features were made accessible. In the case of ICDA2, only the provided training/testing configuration was used, and the results obtained on the provided test set are shown. In the case of ICDA1, the average results of an 11 fold cross-validation setting are shown, where the 600 test samples were split into 10 folds and the training set added as an 11th fold. At each time, one of the 11 folds was added to the source sets to train the classifier and tested on the 600 remaining target documents. As multiple source domains (C, I, P and B) are available, different source combinations can be considered by an exhaustive enumeration of all possible subsets: SCᵢ, i=1, . . . , N_{SC}, where N_{SC}=2⁴−1=15, e.g., SC₁={C}, SC₆={C,P} and SC₁₅={C,I,P,B}. Then for each source combination, the target training set Tₗ was concatenated with the selected sources SCⱼ to build the training set X₁. Denoting the corresponding classifier by f^{SC}^{ⱼ}, to improve the final classification accuracy, the predictions of all these classifiers can be further combined, either using a majority vote or when available by averaging the class prediction scores. In both cases, an unweighted combination was used in the experiments, but weighted fusion could also be used if there is enough data to learn the weights for each SCᵢ combination on a validation set. In a semi-supervised setting such as this f^{SC}^{₀} is also considered in the combination, the classifier learned using only the labeled target set Tₗ. The final prediction obtained as the combinations of all N_{SC}+1 classifiers is denoted by FusAll in the tables below.

### Experimental Results

First, only the original feature space was considered, meaning that no metric learning procedure was applied, with the aim of evaluating the performance of different source domain combinations on the labeling of the target domain samples. Note that when reference is made to “the original image representations,” they are different from the provided image representations as the latter were power normalized from the beginning (Each element of the provided image representation was square rooted yielding a vector with L2 norm, if the original BOV image representation was normalized to have L1 norm). This provides for an increase of 3-5% in accuracy on the baseline SVM and the distance based classifiers, and it explains why the baseline on OffCalSS is higher than noted in the literature.

As a main baseline, for each configuration, the multi-class SVM from the LIBSVM package (www.csie.ntu.edu.tw/cjlin/libsvm/), trained in the original feature space, was used. Using an initial 11 fold cross validation on ICDA1, it was found that v=0:12, C=0:01, and μ=0:5 with the linear kernel performs the best. As only few target examples are in general available for each dataset, these fixed values were used for all datasets. Other parameters, such as the learning rate and number of iterations of the metric learning, were also cross-validated on this ICDA1 setting and then used on all datasets.

1. Evaluation in the Original Feature Space

First, the conventional SVM was compared with distance based classifiers, namely K-Nearest Neighbors (KNN), NCM, NCMC and DSCM. As the first three are not domain adaptation-specific methods, they do not use the domain-specific labels Y_{d} but consider the union of the labeled target and source instances as a single domain training set. In contrast, the present Domain-specific Class Means (DSCM) classifier considers distances to class and domain-specific class means, hence it is able to take advantage of domain-specific labels Y_{d}. In this first set of experiments, fixed weights were used (where wₜ=2 and w_{S}_{ᵢ}=1). In the NCMC classifier, the same number of cluster means per class as the number of domains (NS+1) were used to compare fairly with DSCM. However, the clustering is done in an unsupervised manner and hence there is no guarantee of a correspondence between clusters and domains. The classification results are shown in Tables 1 and 2. Classification performance is evaluated with the original feature space. This means that Eqs. 2 (NCM), 3 (NCMC) and 5 (DSCM) all use W=I.

It can be seen that DSCM outperforms all three distance-based non-parametric classifiers (KNN, NCM and NCMC) for all source combinations; it even outperforms for most configurations (and on average) the multi-class SVM. This indicates that DSCM, even applied without any metric learning, is a suitable classifier for domain adaptation.

TABLE 1
Comparing different classification performance on ICDA1 with
the original feature space

| ICDA1 | SVM | KNN | NCM | NCMC | DSCM |
|---|---|---|---|---|---|
| C | 26.32 | 22.79 | 25.08 | 23.83 | 32.33 |
| I | 31.85 | 25.92 | 23.71 | 21.71 | 32.21 |
| P | 27.32 | 18.91 | 23.83 | 21.06 | 32.89 |
| B | 33.92 | 27.98 | 27.83 | 27.23 | 33.36 |
| C, I | 29.08 | 22.7 | 23.48 | 21.21 | 30.85 |
| C, P | 27.29 | 20.09 | 23.03 | 21.36 | 31.94 |
| C, B | 30 | 26.52 | 26.94 | 25.2 | 31.64 |
| I, P | 29.88 | 19.33 | 24.42 | 20.68 | 30.86 |
| I, B | 36.89 | 27.85 | 24.91 | 23.14 | 30.94 |
| P, B | 30.12 | 22.48 | 26.83 | 23.02 | 32.03 |
| C, I, P | 28.67 | 20.05 | 24.65 | 20.52 | 30.33 |
| C, I, B | 33.42 | 25.79 | 24.44 | 21.55 | 30.17 |
| C, P, B | 28.05 | 22.44 | 26.26 | 22.74 | 30.85 |
| I, P, B | 32.48 | 22.91 | 25.59 | 22.39 | 30.59 |
| C, I, P, B | 29.39 | 22.38 | 24.89 | 22.06 | 29.48 |
| Mean | 30.31 | 23.21 | 25.06 | 23.21 | 31.37 |

TABLE 2
Comparing different classification performance on ICDA2 with
the original feature space

| ICDA2 | SVM | KNN | NCM | NCMC | DSCM |
|---|---|---|---|---|---|
| C | 23 | 22.5 | 11.67 | 13.17 | 26 |
| I | 26.67 | 25.5 | 13.00 | 16.33 | 25.5 |
| P | 25.5 | 20.67 | 19.50 | 15.17 | 24.83 |
| B | 30.5 | 24.17 | 15.33 | 14.83 | 24.67 |
| C, I | 22.67 | 23.50 | 13.5.0 | 13.17 | 25.33 |
| C, P | 21.83 | 21.67 | 16.00 | 11.33 | 26.33 |
| C, B | 26.00 | 23.00 | 12.50 | 13.83 | 26.17 |
| I, P | 26.50 | 17 | 14.33 | 20.33 | 26.67 |
| I, B | 30 | 23.33 | 15.67 | 13.83 | 27.17 |
| P, B | 29.83 | 22.17 | 15 | 22.17 | 26.5 |
| C, I, P | 22 | 22 | 14.17 | 12.5 | 27.33 |
| C, I, B | 27.5 | 21.5 | 14.67 | 18.67 | 24.33 |
| C, P, B | 24.17 | 22.67 | 15.83 | 18.67 | 26.83 |
| I, P, B | 28.17 | 21.33 | 15.5 | 15.83 | 27.67 |
| C, I, P, B | 24.5 | 21.5 | 16 | 17.5 | 26.67 |
| Mean | 25.92 | 22.44 | 14.84 | 22.44 | 26.13 |

2. Evaluation in the Projected Feature Space

For experiments in the learned projected space, metric learning approaches that optimize W for the corresponding classifiers were evaluated. For KNN, a metric learning (denoted here by KNN-ML) similar to that described in Davis, J. V., et al., “Information-theoretic metric learning,” Proc. 24th Intern'l Conf. on Machine learning (ICML), pp. 209-216 (2007); and Weinberger, K., et al., “Distance metric learning for large margin nearest neighbor classification,” J. Machine Learning Res. (JMLR) 10, pp. 207-244 (2009) was used, where the ranking loss is optimized on triplets:

L_{qpn}=max(0,[1+d_{W}(x_{q},xₚ)−d_{W}(x_{q},xₙ)]), (10)

where xₚ is an image from the same class as the query image x_{q} and xₙ is an image from any other class.

The Nearest Class Mean Metric Learning (NCM-ML) optimizes W according to Eq. 2 and the Nearest Class Multiple Centroids classifier based metric learning (NCMC-ML) according to Eq. 3 (see Mensink 2013 for details). The Domain-Specific Class Means-based Metric Learning method (DSCM-ML), as described above, is also evaluated. TABLES 3 and 4 show results obtained. SVM results in the projected space are not included as, in general, a drop in performance was observed, compared to TABLES 1 and 2. The performance decreases of the linear multi-class SVM in the projected space is not surprising as reducing interclass and increasing intraclass distances does not mean improved linear separability between classes, especially when the dimensionality decreases.

TABLE 3
Comparing different distance based classification performance
on ICDA1 with the features in the projected space where the
transformation matrix W is learned with the corresponding objectives

| ICDA1 | KNN-ML | NCM-ML | NCMC-ML | DSCM-ML |
|---|---|---|---|---|
| C | 26.74 | 26.03 | 24.77 | 28.41 |
| I | 29.33 | 27.11 | 28.52 | 32.88 |
| P | 25.94 | 25.27 | 23.88 | 26.5 |
| B | 33.21 | 33.08 | 32.48 | 34.85 |
| C, I | 29.62 | 26.47 | 25.5 | 30.89 |
| C, P | 25.48 | 25.86 | 23.92 | 30.32 |
| C, B | 30.36 | 30.92 | 29.5 | 32.92 |
| I, P | 26.62 | 26 | 26.89 | 31.86 |
| I, B | 33.45 | 32.86 | 33.48 | 35.23 |
| P, B | 28.29 | 31.41 | 27.29 | 33.68 |
| C, I, P | 25.98 | 27.48 | 25.53 | 31.67 |
| C, I, B | 31.15 | 31.33 | 28.89 | 34.68 |
| C, P, B | 28.27 | 29.98 | 28.92 | 32.67 |
| I, P, B | 29.82 | 30.33 | 29.56 | 34.58 |
| C, I, P, B | 29.21 | 29.85 | 28.74 | 33.24 |
| Mean | 28.9 | 28.93 | 27.86 | 32.29 |

TABLE 4
Comparing different distance based classification performance
on ICDA1 with the features in the projected space where the
transformation matrix W is learned with the corresponding objectives

| ICDA2 | KNN-ML | NCM-ML | NCMC-ML | DSCM-ML |
|---|---|---|---|---|
| C | 24.67 | 18.17 | 16.83 | 25.17 |
| I | 28.33 | 25.5 | 24.17 | 30.33 |
| P | 26.33 | 22.83 | 23.67 | 25.33 |
| B | 30.17 | 29 | 30.17 | 34.17 |
| C, I | 25.83 | 19.83 | 18 | 25.67 |
| C, P | 24.83 | 16.17 | 15 | 23.33 |
| C, B | 27.83 | 20.5 | 18.5 | 24.5 |
| I, P | 27.17 | 15 | 22.17 | 29.67 |
| I, B | 30.17 | 25.17 | 21.17 | 33.5 |
| P, B | 28.17 | 25.17 | 22.5 | 30.67 |
| C, I, P | 25 | 15.5 | 16.67 | 27.17 |
| C, I, B | 28.33 | 18.83 | 23.83 | 28.5 |
| C, P, B | 25.17 | 19.5 | 27.5 | 27.83 |
| I, P, B | 29.67 | 22 | 27.33 | 31.83 |
| C, I, P, B | 27.83 | 21.5 | 24.83 | 27.67 |
| Mean | 27.3 | 20.98 | 22.16 | 28.36 |

From TABLES 3 and 4 (and in comparison with TABLES 1 and 2) it can be inferred that:

1. Metric learning significantly improves the classification in the target domain in all cases, even when methods are applied which are not domain-specific, as in KNN-ML, NCM-ML and NCMC-ML. The reason is likely that on the merged dataset, the learning approach is able to take advantage of the class labels to bring the images closer that are from the same class independently of the domains and hence the final classifier is better able to exploit labeled data from the sources in the transformed space than in the original one.

2. When the different metric learning approaches are compared, DSCM-ML out-performs all other methods on ICDA1 and in most cases for ICDA2. The few exceptions are when KNN-ML performs slightly better on ICDA2 than DSCM-ML. It may be noted, however, that for ICDA2, there is only a single test set, while on ICDA1, an average on 11 folds was computed, hence the results suggest that DSCM-ML is consistently better than KNN-ML. Comparing the results to the SVM baseline (see TABLES 1 and 2) it can be seen that DSCM-ML is almost always significantly better than the results obtained with the linear multi-class SVM.

3. Evaluation of SAMLDA with Different Metric Learning Algorithms

The aim of these experiments is to evaluate whether the Self-Adaptive Metric Learning Domain Adaptation (SAMLDA) described in Algorithm 1 can be used to further improve the performance of any of the previously mentioned metric learning approach by iteratively updating the metric W using the unlabeled target examples. Note that in Algorithm 1, the metric yielding the results in TABLES 3 and 4 correspond to the results obtained with W₁. The performance with W₀, corresponding to the PCA projection, was also evaluated, but the results were far below the results obtained with W₁. TABLE 5 provides a comparison of the classification accuracies between a given metric learning using only the initial training set and the metric refined with SAMLDA, where f_{W} in the algorithm is the corresponding metric learning algorithm. Only results on ICDA1 are shown. However, similar behavior was observed on ICDA2.

TABLE 5
Improvements in accuracy for each metric learning method
when the metric is refined with the SAMLDA algorithm

| | | KNN- | | NCM- | | NCMC- | | DSCM- |
|---|---|---|---|---|---|---|---|---|
| | KNN- | ML + | NCM- | ML + | NCMC- | ML + | DSCM- | ML + |
| ICDA1 | ML | SAMLDA | ML | SAMLDA | ML | SAMLDA | ML | SAMLDA |
| C | 26.74 | 27.41 | 26.03 | 27.45 | 24.77 | 25.7 | 28.41 | 28.67 |
| I | 29.33 | 29.67 | 27.11 | 27.89 | 28.52 | 28.56 | 32.88 | 32.68 |
| P | 25.94 | 26.59 | 25.27 | 26.41 | 23.88 | 24.79 | 26.5 | 27.92 |
| B | 33.21 | 33.83 | 33.08 | 34.35 | 32.48 | 33.12 | 34.85 | 35.55 |
| C, I | 29.62 | 30.09 | 26.47 | 28.42 | 25.5 | 25.98 | 30.89 | 31.21 |
| C, P | 25.48 | 26.42 | 25.86 | 27.79 | 23.92 | 24.86 | 30.32 | 32 |
| C, B | 30.36 | 31.03 | 30.92 | 32.97 | 29.5 | 29.95 | 32.92 | 34.59 |
| I, P | 26.62 | 27.77 | 26 | 26.92 | 26.89 | 26.65 | 31.86 | 32.33 |
| I, B | 33.45 | 34.02 | 32.86 | 35.27 | 33.48 | 34.02 | 35.23 | 37.42 |
| P, B | 28.29 | 28.58 | 31.41 | 33.32 | 27.29 | 27.8 | 33.68 | 35.3 |
| C, I, P | 25.98 | 27.15 | 27.48 | 29.27 | 25.53 | 26 | 31.67 | 33.77 |
| C, I, B | 31.15 | 31.77 | 31.33 | 32.91 | 28.89 | 29.74 | 34.68 | 36.52 |
| C, P, B | 28.27 | 28.21 | 29.98 | 32.03 | 28.92 | 29.15 | 32.67 | 34.8 |
| I, P, B | 29.82 | 30.88 | 30.33 | 33.18 | 29.56 | 31.03 | 34.58 | 36.52 |
| C, I, P, | 29.21 | 30.06 | 29.85 | 32.12 | 28.74 | 29.64 | 33.24 | 35.74 |
| Mean | 28.9 | 29.57 | 28.93 | 30.69 | 27.86 | 28.47 | 32.29 | 33.67 |

These results suggest that integrating the SAMLDA algorithm (Algorithm 1) into any of these metric learning approaches tends to improve the classification accuracy (in 58 out of 60 cases—for the two remaining cases the drop is not significant). When SAMLDA is compared with different metrics, the best results are obtained when the DSCM-ML is used as a metric learning approach.

4. Comparing Different Weighting Strategies

Different weighting strategies were compared: fixed weights, weights obtained using TDAS, and weights computed using NCM accuracies.

TABLES 6 and 7 show the effects of different weighting strategies on ICDA1 and ICDA2, respectively, during both training and testing (top 3 rows) and during testing only (bottom 3 rows). The top 3 rows thus show results when the weighting strategy was used in SAMLDA, i.e., when w_{d}^{r} is updated at each iteration, while the bottom rows show results when manually fixed weights were used during the learning and the TDAS or NCM based weights used with the learned metric W only at test time. In all cases, the tables show the mean of all configuration results (as in the tables above), the results for all four sources, and the results obtained as a late fusion of all SCᵢ source combinations (including SC₀).

TABLE 6
Weighting strategies, ICDA1

| | | | |
|---|---|---|---|
| ICDA1 | fixed | TDAS | NCM |

Testing and training

| | | | |
|---|---|---|---|
| Mean | 32.29 | 31.75 | 32.67 |
| C, I, P, B | 33.24 | 31.83 | 34.53 |
| FusAll | 39.18 | 39.29 | 39.86 |

Testing only

| | | | |
|---|---|---|---|
| Mean | 32.29 | 31.69 | 32.88 |
| C, I, P, B | 33.24 | 32.73 | 34.56 |
| FusAll | 39.18 | 38.74 | 39.56 |

TABLE 7
Weighting strategies, ICDA2

| | | | |
|---|---|---|---|
| ICDA2 | fixed | TDAS | NCM |

Testing and training

| | | | |
|---|---|---|---|
| Mean | 27.06 | 28.39 | 27.17 |
| C, I, P, B | 30.67 | 29 | 27.67 |
| FusAll | 38 | 37.17 | 37.5 |

Testing only

| | | | |
|---|---|---|---|
| Mean | 27.06 | 26.72 | 27 |
| C, I, P, B | 30.67 | 28.83 | 33 |
| FusAll | 38 | 37.83 | 37.67 |

From TABLES 6 and 7, the following can be inferred (at least for this type of dataset):

1. The best weighting strategy is generally that obtained using the NCM accuracies. Using TDAS tends to decrease the performance in most cases.

2. Using the weighting strategy only at test time and using fixed weights at training time may be a good compromise as the results are relatively similar. In this way, the training costs may be lower, since there is no need to estimate the weights at each step.

3. It may also be noted that averaging the predictions from all source combinations (FusAll) improves the final results significantly in all cases compared to using the C, I, P, B source combination alone.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A classification system comprising:
memory which stores:
for each of a set of classes, a classifier model for assigning a class probability to a test sample from a target domain, the classifier model having been learned with training samples from the target domain and training samples from at least one source domain different from the target domain, each classifier model modeling the respective class as a mixture of components, the mixture of components including a component for each of the at least one source domain and a component for the target domain, each component being a function of a distance between the test sample and a domain-specific class representation which is derived from the training samples of the respective domain that are labeled with the class, each of the components in the mixture being weighted by a respective mixture weight; and
instructions for labeling the test sample based on the class probabilities assigned by the classifier models; and
a processor in communication with the memory which executes the instructions.

2. The system of claim 1, wherein each component is an exponentially decreasing function of the distance between the test sample and the domain-specific class representation.

3. The system of claim 1, wherein each domain-specific class representation is an average of the training samples of the respective domain that are labeled with the class.

4. The system of claim 1, wherein the distance between the test sample and each domain-specific class representation is computed in an embedding space into which the test sample and each domain-specific class representation is embedded with the same metric.

5. The system of claim 1, where the mixture components are Gaussian functions and the inverse of their covariance is shared and approximated by a low-rank matrix.

6. The system of claim 1, wherein the classifier models are learned by maximizing a sum of the log of the training sample class posteriors.

7. The system of claim 1, wherein the classifier model is of the form:
$$p ( c \vert {x}_{i} ) = \frac{1}{{z}_{i}} {w}_{c} {\sum }_{d = 1}^{D} {w}_{d} ( exp ( - \frac{1}{2} {d}_{W} ( {x}_{i} , {μ}_{d}^{c} ) ) ) \qquad ( 6 )$$
or is a function thereof,
where p(c|xᵢ) represents the posterior probability of the class c for the test sample xᵢ;
w_{c} represents the class specific mixture weight, that can be constant;
w_{d} represents the mixture weight for a respective mixture component exp(−½d_{W}(xᵢ,μ_{d}^{c}), where d_{W}(xᵢ,μ_{d}^{c}) represents the distance between sample xᵢ and the domain-specific class representation μ_{d}^{c} for a domain d selected from the target domain and the at least one source domain, and W represents an optional metric for embedding sample xᵢ and each of the domain-specific class representations μ_{d}^{c} in a common embedding space; and
Zᵢ is an optional normalizing factor.

8. The system of claim 1, wherein the training samples and test sample are multidimensional representations.

9. The system of claim 7, wherein the multidimensional representations are derived from images, videos, sounds, text or other multimedia documents.

10. The system of claim 1, wherein each of the source domain training samples is labeled with a label for one of the classes and fewer than all of the target domain training samples are labeled with a label for any of the classes.

11. The system of claim 9, wherein at least some of the target domain training samples are labeled with a label for at least one of the classes.

12. The system of claim 10, wherein the learning includes for each of a plurality of iterations,
performing at least one of:
adding to an active training set, which is derived from the source domain samples and labeled target domain samples, a most confident unlabeled target domain sample for each class, and
removing from the active training set a least confident source domain sample from each class; and
retraining a metric based on the active training set which is used to embed the test sample and a domain-specific class representation into an embedding space in which the distance is computed.

13. The system of claim 1, wherein the mixture weight for the target domain is higher than for each of the at least one source domains.

14. The system of claim 1, wherein for the test sample, inference is performed by computing the max of the class posteriors.

15. A classifier learning method, comprising:
for each of a set of domains including a target domain and at least one source domain, providing a set of samples, the source domain samples each being labeled with a class label for one of a set of classes, fewer than all of the target domain samples being labeled with any of the class labels;
with a processor, learning a classifier model for each class with the target domain training samples and the training samples from the at least one source domain, each classifier model modeling the respective class as a mixture of components, the mixture of components including a component for each of the at least one source domain and a component for the target domain, each component being a function of a distance between the test sample and a domain-specific class representation which is derived from the training samples of the respective domain that are labeled with the class, each of the components in the mixture being weighted by a respective mixture weight.

16. The method of claim 15, further comprising learning the weights in an iterative process.

17. The method of claim 15, wherein the classifier model includes a metric for embedding samples into an embedding space, the method further comprising learning the metric.

18. The method of claim 15, wherein the learning of the metric comprises:
composing an active training set from the labeled training samples;
initializing the metric for embedding samples in an embedding space;
for each of a plurality of iterations,
a) performing at least one of:
adding to the active training set a most confident unlabeled target domain sample for each class, and
removing from the active training set a least confident source domain sample from each class; and
b) retraining the metric based on the active training set.

19. The method of claim 18, wherein the confidence used to remove and add samples is based on the performance of the classifier model when the metric is used for embedding training samples into the embedding space in which the distance is computed.

20. A system comprising memory which stores instructions for performing the method of claim 15 and a processor in communication with the memory for executing the instructions.

21. A computer program product comprising non-transitory memory storing instructions, which when executed by a processor, perform the method of claim 15.

22. A method for learning a metric for a classifier model comprising:
for each of a set of domains including a target domain and at least one source domain, providing a set of samples, the source domain samples each being labeled with a class label for one of a set of classes, fewer than all of the target domain samples being labeled with any of the class labels;
composing an active training set from the labeled training samples;
providing a metric for embedding samples in an embedding space;
for each of a plurality of iterations,
performing at least one of:
a) adding to the active training set a most confident unlabeled target domain sample for each class, and
b) removing from the active training set a least confident source domain sample from each class; and
retraining the metric based on the active training set, the confidence used to remove and add samples being based on a classifier model that includes the trained metric, where each class is modeled as a mixture of components, and where there is one mixture component for each source domain and one for the target domain.

23. The method of claim 22, wherein for each mixture component there is a weight and the method includes iteratively learning the weights by evaluating a confidence of the classifier model on a set of labeled target domain samples.
